(19) United States
(12) Patent Application Publication
(10) Pub. No.: US 2024/0073519 A1
(43) Pub. Date: Feb. 29, 2024

(54) PHOTODETECTOR AND CONTROL METHOD FOR CONTROLLING PHOTODETECTOR

(71) Applicant: InnoCare Optoelectronics Corporation, Tainan City (TW)

(72) Inventor: Yang-Sheng Chen, Tainan City (TW)

(73) Assignee: InnoCare Optoelectronics Corporation, Tainan City (TW)

(21) Appl. No.: 18/348,376

(22) Filed: Jul. 7, 2023

(30) Foreign Application Priority Data
Aug. 24, 2022 (TW) 111131811

(51) Int. Cl. H04N 23/66; H04N 23/62; H04N 23/63

(52) U.S. Cl. CPC H04N 23/66; H04N 23/62; H04N 23/633

(57) ABSTRACT

A photodetector and a control method are provided. The control method includes: sending a command signal by an external device; receiving the command signal by a signal transceiver, and notifying the command signal to a controller; and performing an operation corresponding to the command signal according to the command signal by the controller.

### CROSS-REFERENCE TO RELATED APPLICATION

This application claims the priority benefit of Taiwan application serial no. 111131811, filed on Aug. 24, 2022. The entirety of the above-mentioned patent application is hereby incorporated by reference herein and made a part of this specification.

### BACKGROUND

### Technical Field

The disclosure relates to a photodetector and a control method for controlling the photodetector, and particularly, to a control method for wirelessly controlling the photodetector.

### Description of Related Art

Generally, to operate a photodetector, operators need to touch the photodetector. For example, the photodetector is operated by touching a button of the photodetector or through a human-machine interface. However, such touch may increase the risk in transmission of bacteria or viruses. In addition, when the photodetector is disposed in a place not easy for operation, a relocation of the photodetector is required for operation.

Therefore, how to provide a convenient photodetector that reduces the spread of bacteria or viruses and a control method for controlling the photodetector is one of the research focuses of those skilled in the art.

### SUMMARY

The disclosure provides a control method for wirelessly controlling a photodetector through an external device. The photodetector includes a processor, a signal transceiver, and a controller. The control method includes steps as follows. A command signal is sent by the external device. The signal transceiver receives the command signal and notifies the controller of the command signal. The controller performs an operation corresponding to the command signal according to the command signal.

The photodetector of the disclosure includes a processor, a signal transceiver, and a controller. The signal transceiver is configured to wirelessly receive a command signal. The controller is connected to the processor and the signal transceiver. The controller performs an operation corresponding to the command signal according to the command signal.

### BRIEF DESCRIPTION OF THE DRAWING

FIG. 1 is a schematic view of a photodetector according to a first embodiment of the disclosure.

FIG. 2 is a flowchart illustrating a control method according to an embodiment of the disclosure.

FIG. 3 is a schematic view of a photodetector according to a second embodiment of the disclosure.

FIG. 4 is a schematic view of a photodetector according to a third embodiment of the disclosure.

FIG. 5 is a schematic view of a photodetector according to a fourth embodiment of the disclosure.

### DESCRIPTION OF THE EMBODIMENTS

Some embodiments of the disclosure will be described in detail with reference to the accompanying drawings. For reference numerals cited in the following descriptions, the same reference numerals appearing in different drawings are regarded as the same or similar elements. The embodiments are only a part of the disclosure and do not disclose all possible implementations of the disclosure. More precisely, the embodiments are merely exemplary within the scope of the disclosure.

Throughout the specification and the appended claims of the disclosure, certain terms are used to refer to specific elements. Those skilled in the art should understand that electronic device manufacturers may probably use different names to refer to the same elements. This specification is not intended to distinguish between elements that have the same function but different names. In the following specification and claims, the terms “including”, “containing”, “having”, etc., are open-ended terms, so they should be interpreted to mean “including but not limited to . . . ”.

Directional terminology mentioned in the specification, such as “top”, “bottom”, “front”, “back”, “left”, “right”, etc., is used with reference to the orientation of the drawings being described. Therefore, the used directional terminology is only intended to illustrate, rather than limit, the disclosure. In the drawings, various drawings illustrate the general characteristics of methods, structures and/or materials used in specific embodiments. However, these drawings should not be interpreted to define or limit the scope or nature encompassed by these embodiments. For example, for clarity, a relative size, a thickness, and a location of each film layer, region, and/or structure may be reduced or enlarged.

In some embodiments of the disclosure, terms such as “bond”, “connect” and “interconnect” with respect to bonding and connection, unless specifically defined, may refer to two structures that are in direct contact with each other, or may refer to two structures that are indirectly in contact with each other, wherein there are other structures set between these two structures. In addition, the terms that describe bonding and connecting may apply to the case where both structures are movable or both structures are fixed. In addition, the term “coupling” involves any direct and indirect electrical connection means. In the case of direct electrical connection, the terminals of the elements on two circuits are directly connected or connected to each other by a conductor segment. In the case of indirect electrical connection, there are switches, diodes, capacitors, inductors, resistors, other suitable elements, or a combination thereof between the terminals of the elements on the two circuits, but they are not limited thereto.

The terms such as “about”, “equal”, “same”, “substantially”, or “approximately” are generally interpreted as being within a range of plus or minus 20% of a given value or range, or as being within a range of plus or minus 10%, plus or minus 5%, plus or minus 3%, plus or minus 2%, plus or minus 1%, or plus or minus 0.5% of the given value or range.

Ordinal numbers such as “first”, “second”, etc., used in the specification and claims are used to modify elements, and they do not imply and represent that this or these elements have any previous ordinal numbers, nor do they represent an order of one element over another, or an order of a manufacturing method, and the use of these ordinal numbers is only used to clearly distinguish an element with a certain name from another element with the same name. The claims and the specification may not use the same terms, whereby a first element in the specification may be a second element in the claim. In the disclosure, the features of multiple embodiments to be described below may be replaced, recombined, or mixed to form other embodiments without departing from the spirit of the disclosure.

In the disclosure, the features of multiple embodiments to be described below may be replaced, recombined, or mixed to form other embodiments without departing from the spirit of the disclosure. The features of multiple embodiments may be used in combination as long as such combination does not depart from the spirit of the disclosure or lead to conflict.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The electronic device in the disclosure may include a photodetection device or a splicing device, but the disclosure is not limited thereto. The electronic device (e.g. a photodetector) may be a bendable or flexible electronic device. In the disclosure, the electronic device (e.g. a photodetector) may include electronic elements, and the electronic elements may include passive elements and active elements, such as capacitors, resistors, inductors, diodes, transistors, and the like. The diodes may include light-emitting diodes or photodiodes. The light-emitting diodes may include, for example, organic light-emitting diodes (OLEDs), mini LEDs, micro LEDs, or quantum dot LEDs, but the disclosure is not limited thereto. A detection device is configured as an electronic device or a splicing device to illustrate the content of the disclosure in the following, but the disclosure is not limited thereto.

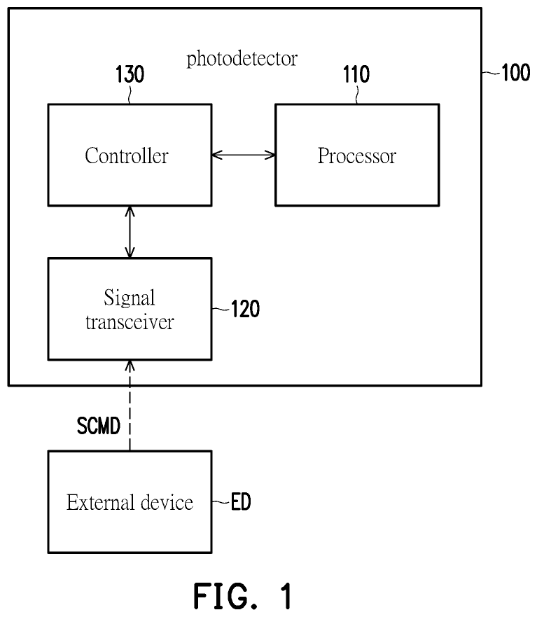

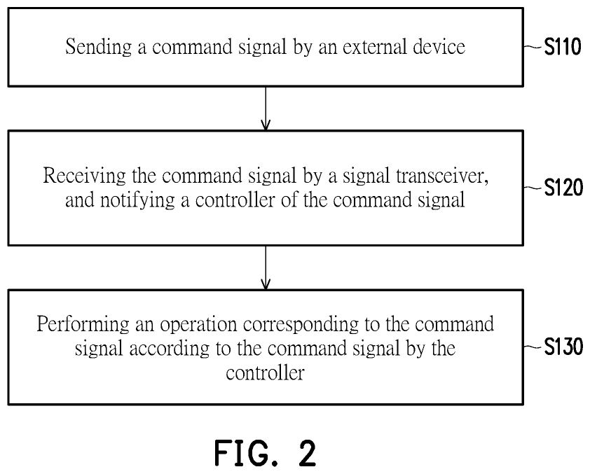

Referring to both FIG. 1 and FIG. 2, FIG. 1 is a schematic view of a photodetector according to a first embodiment of the disclosure, and FIG. 2 is a flowchart illustrating a control method according to an embodiment of the disclosure. A photodetector 100 is a detection device, such as a visible photodetector, an infrared photodetector, and an X-ray detector, for example, but the disclosure is not limited thereto. In the embodiment, the photodetector 100 includes a processor 110, a signal transceiver 120, and a controller 130. The signal transceiver 120 is configured to wirelessly receive a command signal SCMD. The controller 130 is connected to the processor 110 and the signal transceiver 120. The controller 130 is configured to perform an operation corresponding to the command signal according to the command signal. In the embodiment, the control method may be applied to the photodetector 100. The control method wirelessly controls the photodetector 100 through an external device ED. In step S110, the external device ED sends the command signal SCMD. Specifically, the external device ED wirelessly communicates with the signal transceiver 120. Specifically, the external device ED wirelessly sends the command signal SCMD. In step S120, the signal transceiver 120 wirelessly receives the command signal SCMD and notifies the controller 130 of the command signal SCMD. In step S130, the controller 130 performs an operation corresponding to the command signal SCMD according to the command signal SCMD. The controller 130 controls the processor 110 according to the command signal SCMD. For example, the controller 130 can operate the internal elements of the photodetector 100 according to the command signal SCMD provided by the external device ED, and the internal elements perform functions corresponding to the command signal SCMD. In addition, the controller 130 can control the processor 110 to perform setting and/or signal processing of the photodetector 100 according to the command signal SCMD.

The photodetector 100 wirelessly receives the command signal SCMD through the signal transceiver 120. According to the command signal SCMD, the controller 130 performs an operation corresponding to the command signal SCMD and/or controls the processor 110. Accordingly, the risk in transmission of bacteria or viruses through the photodetector can be reduced. The external device ED can remotely and wirelessly control the photodetector 100, thereby facilitating the use of the photodetector 100.

In the embodiment, the external device ED may be a portable device with wireless transmission function and/or computing capability. For example, the external device ED may include a device, such as a smart phone, a smart wearable device, a laptop computer, a desktop computer, a tablet computer, or the like, but the disclosure is not limited thereto.

In some embodiments, the wireless transmission includes, for example, at least one of Bluetooth, infrared, Wifi, Wireless USB, ZigBee, EnOcean, or the like, but the disclosure is not limited thereto. Therefore, the signal transceiver 120 may be a wireless communication circuit capable of supporting transmission protocols of at least one of Bluetooth, infrared, Wifi, Wireless USB, ZigBee and EnOcean, but the disclosure is not limited thereto. The controller 130 is a central processing unit (CPU), for example. The processor 110 is a microprocessor, a digital signal processor (DSP), a programmable controller, an application specific integrated circuit (ASIC), a programmable logic device (PLD), other similar devices, or a combination thereof, for example. The processor 110 can load and execute computer programs.

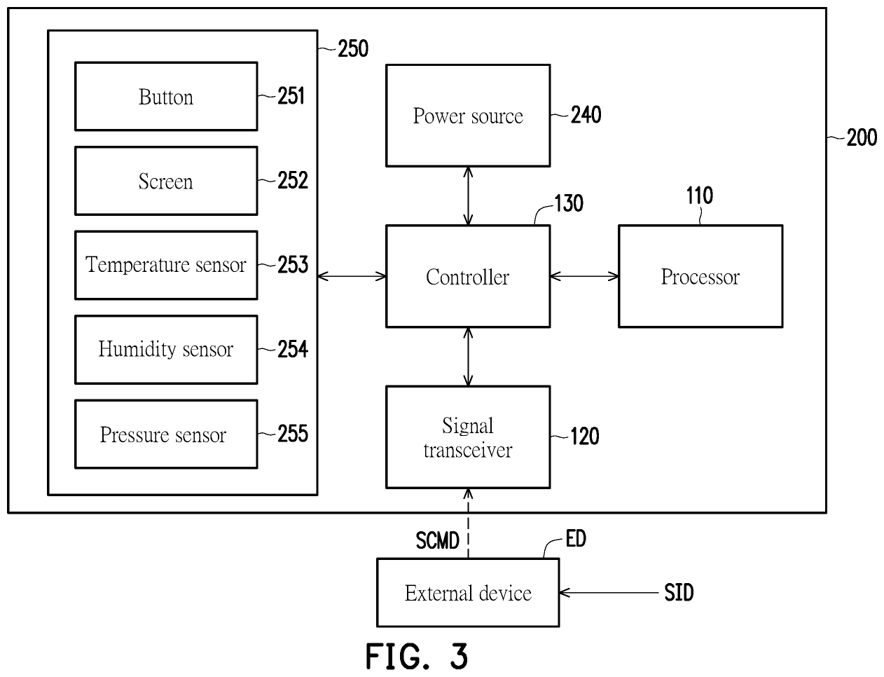

Referring to FIG. 3, FIG. 3 is a schematic view of a photodetector according to a second embodiment of the disclosure. In the embodiment, a photodetector 200 includes the processor 110, the signal transceiver 120, the controller 130, a power source 240, and/or a peripheral element group 250. The power source 240 and/or the peripheral element group 250 are connected to the controller 130, for example. In some embodiments, the peripheral element group 250 of the photodetector 200 may include a button 251, a screen 252, a temperature sensor 253, a humidity sensor 254, a pressure sensor 255, other functional sensors, or other suitable elements.

In some embodiments, the controller 130 displays information sent by the external device ED on the screen 252. The screen 252 may include display devices that provide display functions, such as a liquid crystal display (LCD), light-emitting diodes (LEDs), organic light-emitting diodes (OLEDs), and the like. In some embodiments, the temperature sensor 253 may be configured to sense the ambient temperature of the location where the photodetector 200 is located, but the disclosure is not limited thereto. The humidity sensor 254 may be configured to sense the ambient humidity of the location where the photodetector 200 is located, but the disclosure is not limited thereto. The pressure sensor 255 may be configured to sense the touch pressure of the sensing object on the photodetector 200, but the disclosure is not limited thereto.

In some embodiments, the external device ED may provide the command signal SCMD for changing the power state of the photodetector 200. The signal transceiver 120 may receive the command signal SCMD provided by the external device ED and notify the controller 130 of the command signal SCMD. The controller 130 can identify the command signal SCMD. When the command signal SCMD is a power state command signal for turning on or turning off the power source 240, the controller 130 controls the on or off of the power source 240 according to the command signal SCMD.

For example, the controller 130 may turn on the power source 240 according to the command signal SCMD. When the power source 240 is turned on, the photodetector 200 may enter a power-on state or may be awakened from a low power state (e.g., a sleep state) to a working state. The power source 240 provides the peripheral element group 250 and/or the processor 110 with driving power. In addition, when the power source 240 is turned on, the button light of the button 251 may illuminate. In addition, when the power source 240 is turned on, the screen 252 may be turned on, for example, to display a message or an image indicating that the power state of the photodetector 200 is changed, but the disclosure is not limited thereto. In addition, when the power source 240 is turned on, optionally, the temperature sensor 253, the humidity sensor 254, and/or the pressure sensor 255 may be turned on.

For example, the controller 130 turns off the power source 240 according to the command signal SCMD. When the power source 240 is turned off, the photodetector 200 may enter a shutdown state. When the power source 240 is turned off, the power source 240, for example, stops providing driving power to at least some elements of the peripheral element group 250 and/or the processor 110. When the power source 240 is turned off, the button light of the button 251 stops illuminating. When the power source 240 is turned off, the screen 252 may display a message or an image indicating that the power state of the photodetector 200 is changed. When the power source 240 is turned off, the temperature sensor 253, the humidity sensor 254, and/or the pressure sensor 255 may be turned off. In other embodiments, the controller 130 controls the power source 240 to switch from the working state to the low power state according to the command signal SCMD.

In some embodiments, the external device ED may detect an identification signal SID. The signal transceiver 120 may receive the command signal SCMD provided by the external device ED and notify the controller 130 of the command signal SCMD, but the disclosure is not limited thereto.

In some embodiments, for example, the photodetector 200 is an X-ray detector for medical use or health check, but the disclosure is not limited thereto. In some embodiments, the external device ED can scan the identification codes of patients and staff (doctors, nurses, operating personnel, but the disclosure is not limited thereto) to obtain the identification signal SID. The identification codes include a one-dimensional barcode, a two-dimensional barcode, or other symbolic codes, for example. In some examples, the external device ED can obtain the identification signal SID by a near field communication method to obtain the identity information of the patients and the staff, but the disclosure is not limited thereto.

In some embodiments, the controller 130 receives information in the photodetector 200 and sends the information to the external device ED. The information includes temperature information, humidity information, pressure information, version information, network setting information, and time information, or other suitable information, but the disclosure is not limited thereto. In some embodiments, the controller 130 may receive sensing information generated by the temperature sensor 253, the humidity sensor 254, and/or the pressure sensor 255 and send a sensing signal to the external device ED through the signal transceiver 120, but the disclosure is not limited thereto. In addition, for example, the processor 110 may feedback the setting information and/or the signal processing information of the photodetector 200 to the controller 130, but the disclosure is not limited thereto. The controller 130 may send the setting information and/or the signal processing information of the processor 110 to the external device ED through the signal transceiver 120.

In some embodiments, at least one element of the peripheral element group 250 may be omitted, or other elements may be added optionally, and the disclosure is not limited to the embodiment.

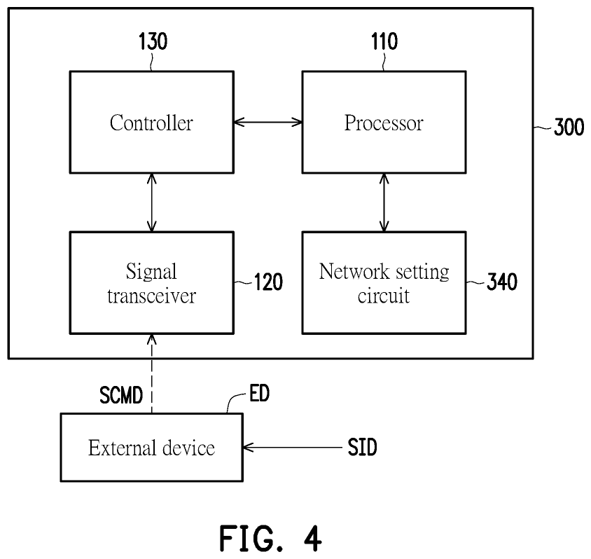

Referring to FIG. 4, FIG. 4 is a schematic view of a photodetector according to a third embodiment of the disclosure. In some embodiments, a photodetector 300 includes the processor 110, the signal transceiver 120, the controller 130, and/or a network setting circuit 340. The network setting circuit 340 may be connected to the processor 110. When the command signal SCMD is a signal for switching network settings, the controller 130 can notify the processor 110 to switch the network settings according to the command signal SCMD. The processor 110 may control the network setting circuit 340 to switch the setting of the network connection according to the command signal SCMD so that the external device ED may switch the setting of the network connection of the photodetector 300 wirelessly.

In some embodiments, the processor 110 may feedback the result information of the network setting to the controller 130. The controller 130 may send the result information of the network setting to the external device ED through the signal transceiver 120, but the disclosure is not limited thereto.

In some embodiments, the photodetector 300 may include the power source 240 and/or the peripheral element group 250 as shown in FIG. 3. The implementation details of the power source 240 and/or the peripheral element group 250 have been clearly illustrated in the embodiment of FIG. 3, which therefore is not repeated herein.

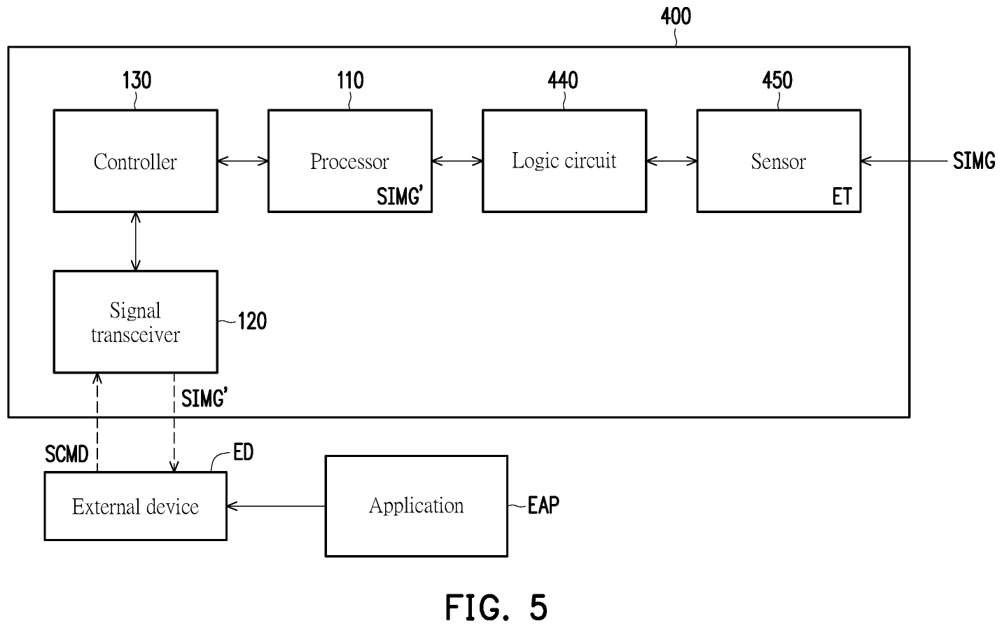

Referring to FIG. 5, FIG. 5 is a schematic view of a photodetector according to a fourth embodiment of the disclosure. In the embodiment, the photodetector 400 includes the processor 110, the signal transceiver 120, the controller 130, a logic circuit 440, and/or a sensor 450. The logic circuit 440 may be connected to the controller 130 or the processor 110. The logic circuit 440 may be connected between the controller 130 (or the processor 110) and the sensor 450. The logic circuit 440 can collect an image signal SIMG received by the photodetector 400. The processor 110 may perform image processing on the image signal SIMG to generate a processed image signal SIMG′. For example, the processor 110 may perform format conversion processing and/or compression processing on the image signal SIMG to generate the processed image signal SIMG′, but the disclosure is not limited thereto. Therefore, the file size and/or format of the processed image signal SIMG′ and the file size and/or format of the image signal SIMG may be different. In some embodiments, the controller 130 may receive the processed image signal SIMG′ and send the processed image signal SIMG′ to the external device ED through the signal transceiver 120, but the disclosure is not limited thereto.

In some embodiments, the external device ED sends the command signal SCMD. When the command signal SCMD is a signal for shooting according to a set exposure time ET, the controller 130 can notify the sensor 450 to capture the image signal SIMG according to the set exposure time ET through the logic circuit 440, but the disclosure is not limited thereto.

In some embodiments, the logic circuit 440 may include a field programmable gate array (FPGA), but the disclosure is not limited thereto. The sensor 450 may be implemented by including an image capturing element for capturing X-ray image signals.

In some embodiments, the exposure time ET may be set by an external application EAP. The external device ED may receive the exposure time ET set by the application EAP and generate the command signal SCMD for shooting according to the set exposure time ET. The external device ED sends the command signal SCMD to the signal transceiver 120. The controller 130 may receive the command signal SCMD through the signal transceiver 120 and recognize that the command signal SCMD is a signal for shooting according to the exposure time ET. The controller 130 may notify the logic circuit 440 to control the sensor 450 so that the sensor 450 captures the image signal SIMG based on the exposure time ET.

In some embodiments, the logic circuit 440 may collect the image signal SIMG and provide the processor 110 with the collected image signal SIMG. The processor 110 may perform format conversion processing and/or compression processing on the image signal SIMG to generate the processed image signal SIMG′ and provide the controller 130 with the processed image signal SIMG′. The controller 130 sends the processed image signal SIMG′ to the external device ED through the signal transceiver 120. In some embodiments, the external device ED can display the processed image signal SIMG′ by the application EAP, but the disclosure is not limited thereto.

In the embodiment, the application EAP may be built in devices other than the external device ED, for example. In some embodiments, the photodetector 400 may include the power source 240 and the peripheral element group 250 shown in FIG. 3 and the network setting circuit 340 shown in FIG. 4. The implementation details of the power source 240, the peripheral element group 250, and the network setting circuit 340 have been clearly illustrated in the embodiments of FIG. 3 and FIG. 4, which therefore are not repeated herein.

In summary, the photodetector and the control method of the disclosure wirelessly receive the command signal through the signal transceiver. The controller performs an operation corresponding to the command signal according to the command signal and controls the processor. The disclosure controls the photodetector wirelessly to perform the operation corresponding to the command signal. Accordingly, the disclosure may facilitate the use of the photodetector and reduce the risk in transmission of bacteria and viruses through the photodetector.

Although the disclosure has been described with reference to the above embodiments, they are not intended to limit the disclosure. It will be apparent to one of ordinary skill in the art that modifications and changes to the described embodiments may be made without departing from the spirit and the scope of the disclosure. Accordingly, the scope of the disclosure will be defined by the attached claims and their equivalents and not by the above detailed descriptions.

What is claimed is:

1. A control method for wirelessly controlling a photodetector through an external device, wherein the photodetector comprises a processor, a signal transceiver, and a controller, wherein the control method comprises:
sending a command signal by the external device;
receiving the command signal and notifying the controller of the command signal by the signal transceiver; and
performing an operation corresponding to the command signal by the controller according to the command signal.

2. The control method for wirelessly controlling the photodetector through the external device of claim 1, wherein the wireless method comprises at least one of bluetooth, infrared, Wifi, Wireless USB, ZigBee, and EnOcean.

3. The control method for wirelessly controlling the photodetector through the external device of claim 1, wherein the photodetector further comprises a power source, wherein the step of performing the operation corresponding to the command signal by the controller according to the command signal comprises:
controlling the power source to be on or off by the controller when the command signal is a signal for turning on or turning off the power source.

4. The control method for wirelessly controlling the photodetector through the external device of claim 1, wherein the step of performing the operation corresponding to the command signal by the controller according to the command signal comprises:
notifying the processor to switch network settings according to the command signal when the command signal is a signal for switching the network settings.

5. The control method for wirelessly controlling the photodetector through the external device of claim 1, wherein the photodetector further comprises a screen, wherein the step of performing the operation corresponding to the command signal by the controller according to the command signal comprises:
displaying information sent by the external device on the screen.

6. The control method for wirelessly controlling the photodetector through the external device of claim 1, further comprising:
receiving information from the photodetector and sending the information to the external device.

7. The control method for wirelessly controlling the photodetector through the external device of claim 1, wherein the photodetector further comprises a logic circuit and a sensor, the logic circuit is connected between the controller and the sensor, wherein the control method further comprises:
collecting an image signal received by the sensor by the logic circuit; and
performing image processing on the image signal by the processor to generate a processed image signal.

8. The control method for wirelessly controlling the photodetector through the external device of claim 7, further comprising:
when the command signal is a signal for shooting according to a set exposure time, notifying the sensor to capture the image signal by the controller according to the exposure time through the logic circuit.

9. The control method for wirelessly controlling the photodetector through the external device of claim 8, wherein the exposure time is set by an application.

10. The control method for wirelessly controlling the photodetector through the external device of claim 7, further comprising:
providing the controller with the processed image signal by the processor;
sending the processed image signal by the controller to the external device through the signal transceiver; and
displaying the processed image signal by the external device.

11. A photodetector, comprising:
a processor;
a signal transceiver configured to wirelessly receive a command signal; and
a controller connected to the processor and the signal transceiver and configured to perform an operation corresponding to the command signal according to the command signal.

12. The photodetector of claim 11, wherein the wireless method comprises at least one of bluetooth, infrared, Wifi, Wireless USB, ZigBee, and EnOcean.

13. The photodetector of claim 11, wherein the photodetector further comprises:
a power source, wherein when the command signal is a signal for turning on or turning off the power source, the controller controls the power source to be on or off.

14. The photodetector of claim 11, wherein when the command signal is a signal for switching network settings, the controller notifies the processor to switch network settings according to the command signal.

15. The photodetector of claim 11, wherein the photodetector further comprises:
a screen, wherein the controller displays information sent by the external device on the screen.

16. The photodetector of claim 11, wherein the controller receives information from the photodetector and sends the information to the external device.

17. The photodetector of claim 11, wherein the photodetector further comprises:
a sensor configured to receive an image signal; and
a logic circuit connected between the controller and the sensor and configured to collect the image signal received by the sensor,
wherein the processor performs image processing on the image signal to generate a processed image signal.

18. The photodetector of claim 17, wherein when the command signal is a signal for shooting according to a set exposure time, the controller notifies the sensor to capture the image signal according to the exposure time through the logic circuit.

19. The photodetector of claim 18, wherein the exposure time is set by an application.

20. The photodetector of claim 17, wherein:
the processor provides the controller with the processed image signal,
the controller sends the processed image signal to the external device through the signal transceiver,
the external device displays the processed image signal.
